(19) United States
(12) Patent Application Publication
(10) Pub. No.: US 2021/0398246 A1
(43) Pub. Date: Dec. 23, 2021

(54) METHOD FOR RECONSTRUCTING AN IMAGE

(71) Applicant: V5 TECHNOLOGIES CO., LTD., Hsinchu City (TW)

(72) Inventors: Sheng-Chih HSU, Hsinchu City (TW); Chien-Ting CHEN, Hsinchu City (TW)

(21) Appl. No.: 17/125,316

(22) Filed: Dec. 17, 2020

(30) Foreign Application Priority Data
Jun. 19, 2020 (TW) 109120823

(51) Int. Cl. G06T 3/40; G06T 7/13; G06T 7/60; G06T 7/136

(52) U.S. Cl. CPC G06T 3/403; G06T 7/13; G06T 2207/30148; G06T 7/136; G06T 7/60

(57) ABSTRACT

A method for reconstructing an image includes: defining a foreground area that is associated with an object in an original image; identifying a plurality of contour points that define a contour of the object, and obtaining a centroid of the object based on the contour points; obtaining a plurality of characteristic lines, each defined by the centroid of the object and an end point obtained from the contour points; and rearranging the characteristic lines by aligning the end points on one side to form a straight edge and making the characteristic lines adjoin each other side by side, so as to construct a reconstructed image.

### CROSS-REFERENCE TO RELATED APPLICATION

This application claims priority of Taiwanese Patent Application No. 109120823, filed on Jun. 19, 2020.

### FIELD

The disclosure relates to a method for reconstructing an image.

### BACKGROUND

Conventionally, a digital image with a relatively large size (e.g., a digital image of a semiconductor wafer) may be difficult to inspect, due to limitations in displaying. For example, in inspecting the digital image for defects on the semiconductor wafer on a display screen with a relatively smaller size, an inspector may frequently need to manually drag the digital image in two directions (i.e., up-down direction and left-right direction) so as to be able to see all parts of the digital image.

### SUMMARY

One object of the disclosure is to provide a method for method for reconstructing an image from an original image with a relatively larger size.

According to one embodiment of the disclosure, a method for reconstructing an image is to be implemented using a processor of an electronic device, and includes the step of:

a) obtaining an original image;

b) defining a foreground area that is associated with an object in the original image;

c) identifying a plurality of contour points that define a contour of the object, and obtaining a centroid of the object based on the contour points;

d) obtaining a plurality of characteristic lines, each of the characteristic lines being defined by the centroid of the object and an endpoint that is obtained from the contour points;

e) obtaining, for each of the characteristic lines, a plurality of pixel value sets that correspond respectively with a plurality of pixels on the original image that constitute the characteristic line; and

f) rearranging the characteristic lines by aligning the end points on one side to form a straight edge and making the characteristic lines adjoin each other side by side, so as to construct a reconstructed image.

### BRIEF DESCRIPTION OF THE DRAWINGS

Other features and advantages of the disclosure will become apparent in the following detailed description of the embodiments with reference to the accompanying drawings, of which:

FIG. 1 is a schematic diagram illustrating an original image that contains a circular object and that is being processed according to one embodiment of the disclosure;

FIG. 2 is a flow chart illustrating steps of a method for reconstructing the original image according to one embodiment of the disclosure;

FIG. 3 is a schematic diagram illustrating a reconstructed image obtained by reconstructing the original image according to one embodiment of the disclosure;

FIG. 4 is a schematic diagram illustrating a cut image obtained by cutting the reconstructed image according to one embodiment of the disclosure;

FIG. 5 is a schematic diagram illustrating another original image that contains an elliptical object and that is being processed according to one embodiment of the disclosure;

FIG. 6 is a flow chart illustrating steps of a method for reconstructing the original image according to one embodiment of the disclosure;

FIG. 7 is a schematic diagram illustrating a reconstructed image obtained by reconstructing the original image according to one embodiment of the disclosure;

FIG. 8 is a schematic diagram illustrating a cut image obtained by cutting the reconstructed image according to one embodiment of the disclosure;

FIG. 9 is a schematic diagram illustrating another original image that contains an approximately elliptical object and that is being processed according to one embodiment of the disclosure;

FIG. 10 is a flow chart illustrating steps of a method for reconstructing the original image according to one embodiment of the disclosure;

FIG. 11 is a schematic diagram illustrating a reconstructed image obtained by reconstructing the original image according to one embodiment of the disclosure;

FIG. 12 is a schematic diagram illustrating a cut image obtained by cutting the reconstructed image according to one embodiment of the disclosure; and

FIG. 13 is a block diagram illustrating an exemplary electronic device for implementing the method according to one embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

Throughout the disclosure, the term “coupled to” may refer to a direct connection among a plurality of electrical apparatus/devices/equipments via an electrically conductive material (e.g., an electrical wire), or an indirect connection between two electrical apparatus/devices/equipments via another one or more apparatus/device/equipment, or wireless communication.

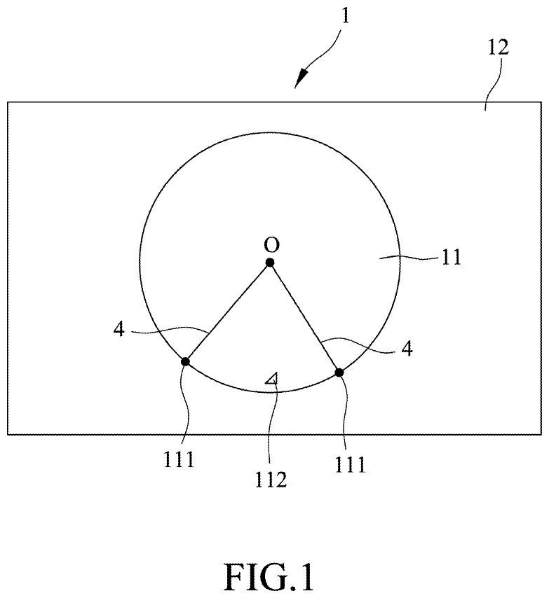

FIG. 1 is a schematic diagram illustrating an original image 1 according to one embodiment of the disclosure. In this embodiment, the original image 1 includes a captured object which substantially has a circular shape and which may be an image of a semiconductor wafer.

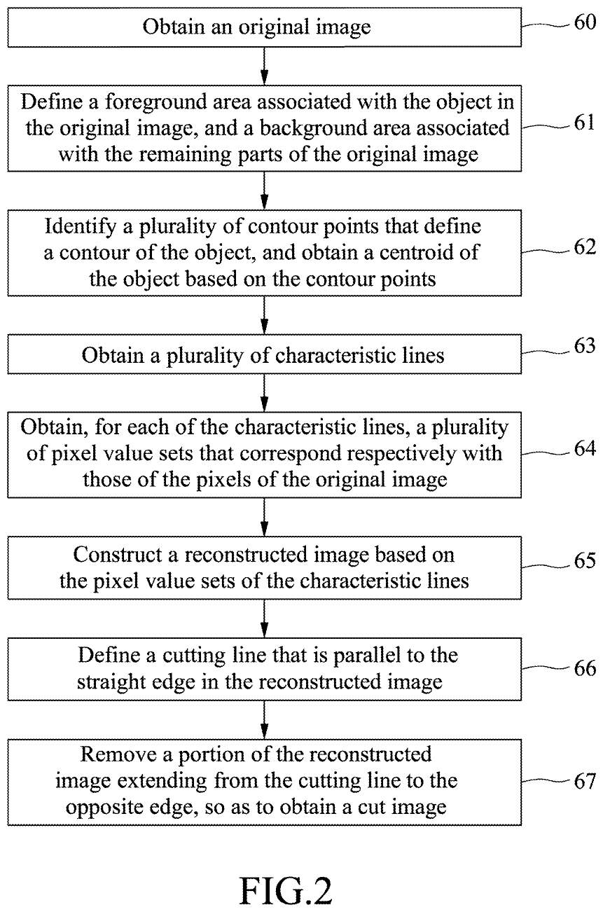

FIG. 2 is a flow chart illustrating steps of a method for reconstructing an original image to obtain a reconstructed image, according to one embodiment of the disclosure. In this embodiment, the method is implemented by a processor of an electronic device.

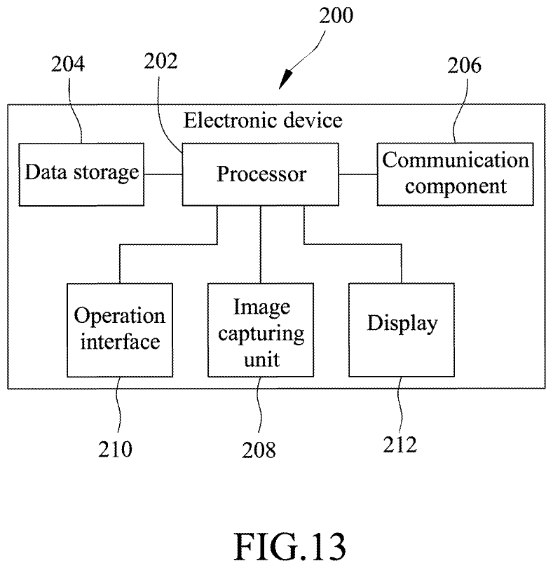

FIG. 13 is a block diagram illustrating an exemplary electronic device 200 configured to implement the method for reconstructing the original image 1 according to one embodiment of the disclosure. In this embodiment, the electronic device 200 may be embodied using a personal computer (PC), a laptop, a tablet, a mobile device (e.g., a smartphone), or the like.

The electronic device 200 includes a processor 202, a data storage 204, a communication component 206, an image capturing unit 208, an operation interface 210 and a display 212.

The processor 202 may include, but not limited to, a single core processor, a multi-core processor, a dual-core mobile processor, a microprocessor, a microcontroller, a digital signal processor (DSP), a field-programmable gate array (FPGA), an application specific integrated circuit (ASIC), a radio-frequency integrated circuit (RFIC), etc.

The data storage 204 is coupled to the processor 202, and may be embodied using random access memory (RAM), read only memory (ROM), programmable ROM (PROM), firmware, flash memory, etc. The data storage 204 stores instructions that, when executed by the processor 202, cause the processor 202 to perform the operations as depicted in FIG. 2.

The communication component 206 is coupled to the processor 202, and may include at least one of a radio-frequency integrated circuit (RFIC), a short-range wireless communication module supporting a short-range wireless communication network using a wireless technology of Bluetooth® and/or Wi-Fi, etc., a mobile communication module supporting telecommunication using Long-Term Evolution (LTE), the third generation (3G) and/or fifth generation (5G) of wireless mobile telecommunications technology, or the like.

The image capturing unit 208 is coupled to the processor 202, and may be embodied using a camera that is capable of capturing a digital image.

The operation interface 210 is coupled to the processor 202, and may be embodied using a mouse, a keyboard, and/or the like. In some cases, the operation interface 210 and the display 212 may be integrated in the form of a touch screen.

In use, a user may operate the operation interface 210 to initiate the method of FIG. 2.

In step 60, the processor 202 obtains an original image (e.g., the original image 1 shown in FIG. 1). In some embodiments, the original image 1 may be captured by the image capturing unit 208, or received from an external source (not shown) via the communication component 206 over a network such as the Internet. As shown in FIG. 1, the original image 1 contains an object that may be a semiconductor wafer in this embodiment and that has a defect 112.

In step 61, the processor 202 defines a foreground area 11 that is associated with the object in the original image 1, and a background area 12 that is associated with the remaining parts of the original image 1.

In step 62, the processor 202 identifies a plurality of contour points 111 that define a contour of the object, and obtains a centroid of the object (O) based on the contour points 111. In the example of FIG. 1, the processor 202 performs binarization on the original image 1 so as to distinguish the object (i.e., the foreground area 11) from the background area 12 in the original image 1, identifies the contour of the foreground area 11, and then identifies the contour points 111 on the contour. In this example, the object has a circular shape, the contour points 111 constitute a circumference of the object, and the centroid of the object (O) is the centre of the object. It should be noted that the contour points 111 shown in FIG. 1 are only for exemplary purposes, and a mass of the contour points 111 that compose the contour of the foreground area 11 may be identified in practice.

In step 63, the processor 202 obtains a plurality of characteristic lines 4. Each of the characteristic lines 4 is a straight line defined by the centroid of the object (O) and an end point that is obtained from the contour points 111, and has a predetermined width (e.g., a predetermined number of pixels). It is noted that in this embodiment, the end point of each of the characteristic lines 4 is a corresponding one of the contour points 111, and each of the characteristic lines 4 is a radius of the object. In one embodiment, each contour point 111 is a pixel on the contour and the number of contour points 111 equals the number of pixels on the contour.

In step 64, the processor 202 obtains, for each of the characteristic lines 4, a plurality of pixel value sets that correspond respectively with those of the pixels of the original image 1 that constitute the characteristic line 4.

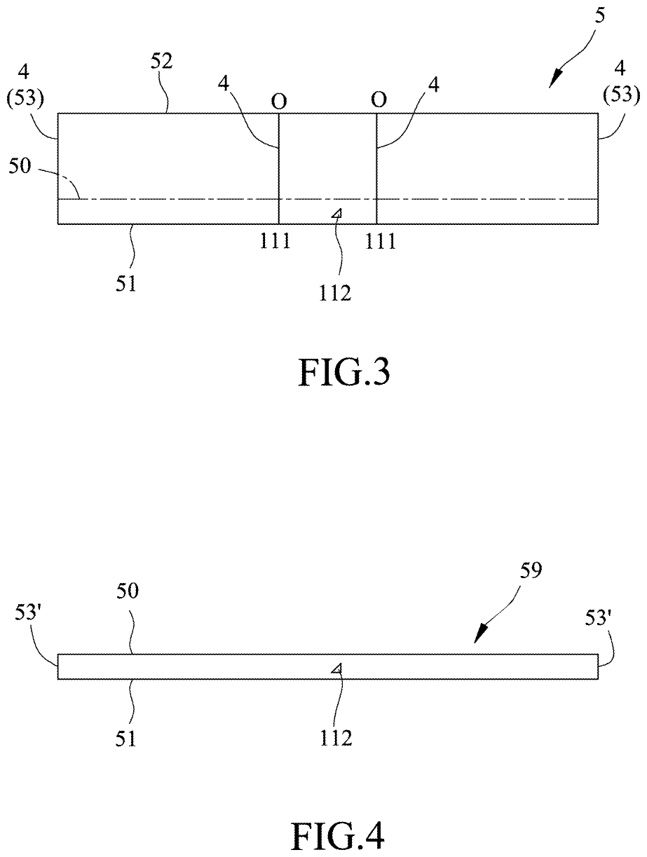

In step 65, the processor 202 constructs a reconstructed image 5 (see FIG. 3) based on the pixel value sets of the characteristic lines 4 obtained in step 64. Specifically, as shown in FIG. 3, the processor 202 rearranges the characteristic lines 4 by aligning the end points (i.e., the contour points 111) on one side to form a straight edge 51 and making the characteristic lines 4 adjoin each other side by side, so as to construct the reconstructed image 5 (only two characteristic lines 4 that are spaced apart from each other are depicted for illustration purposes). Specifically, the reconstructed image 5 is constituted by the pixel value sets of each of the characteristic lines 4, and is defined by the straight edge 51, an opposite edge 52 that is opposite to the straight edge 51 and that is formed by duplicates of the centroid of the object (O) which respectively define the characteristic lines 4, and two of the characteristic lines 4 that are arranged furthest to the sides and that serve as two perpendicular edges 53. In the case where the object is circular in shape, the opposite edge 52 is a straight line.

Afterward, the processor 202 may control the display 212 to display the reconstructed image 5, enabling the user to inspect the reconstructed image 5 to locate the defect 112. Once the defect 112 is found, the user may operate the operation interface 210 to click on the defect 112 on the reconstructed image 5, and the processor 202, in response to the user operation of clicking, controls the display 212 to display and enlarge a part of the original image 1 on which the defect 112 is located.

In some embodiments, after step 65, the processor 202 is further configured to perform the following steps.

In step 66, the processor 202 defines a cutting line 50 that is parallel to the straight edge 51 in the reconstructed image 5. In this embodiment, the cutting line 50 is defined as a straight line that is parallel to and spaced apart from the straight edge 51 by a predetermined distance (d). For example, in the case that the defect 112 is a residue of edge bead removal (EBR), a location of the defect 112 typically is close to an edge of the semiconductor wafer, and a distance from the location of the defect 112 to the edge of the semiconductor wafer may be smaller than 7 millimeters. As a result, the predetermined distance (d) may be set at 7 millimeters.

In step 67, the processor 202 removes a portion of the reconstructed image 5 extending from the cutting line 50 to the opposite edge 52, so as to obtain a cut image 59 (see FIG. 4) defined by the cutting line 50, the straight edge 51 and two segments 53′ respectively of the perpendicular edges 53.

It is noted that, since the predetermined distance (d) is significantly smaller than the radius of the object (typically inches), a size of the cut image 59 is also significantly smaller than the reconstructed image 5. In this manner, the inspection of the defect 112 may be performed with relatively more ease.

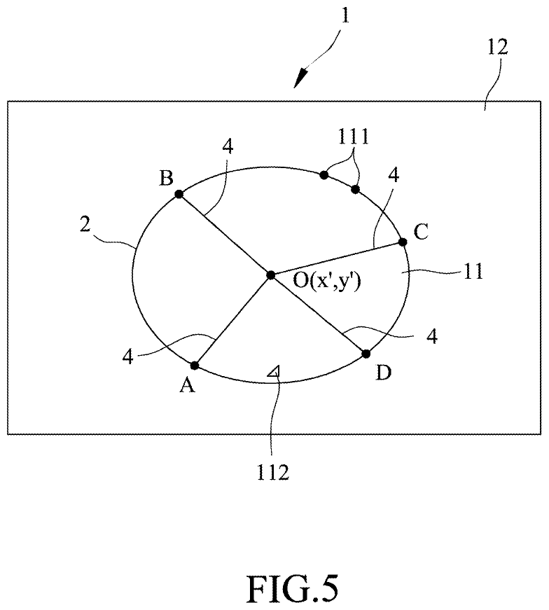

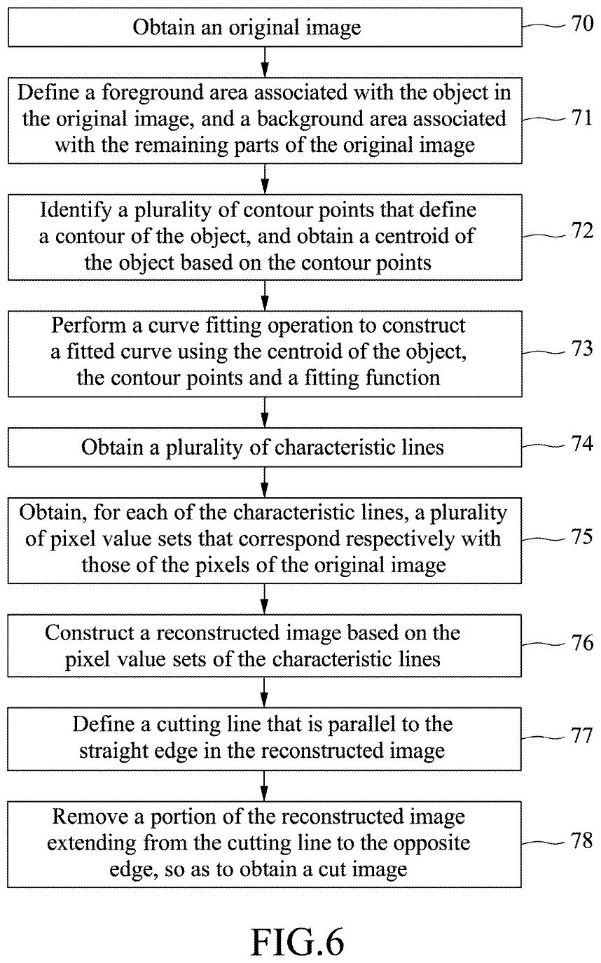

FIG. 6 is a flow chart illustrating steps of a method for reconstructing an original image (e.g., the original image 1 shown in FIG. 5) according to one embodiment of the disclosure. In this embodiment, the object may be a semiconductor wafer having an elliptical shape, as shown in FIG. 5. The object also has a defect 112.

In step 70, the processor 202 obtains an original image (e.g., the original image 1 shown in FIG. 5). In some embodiments, the original image 1 may be captured by the image capturing unit 208, or received from an external source via the communication component 206 over a network such as the Internet. As shown in FIG. 5, the original image 1 contains an object that may be a semiconductor wafer in this embodiment, and that has a defect 112.

In step 71, the processor 202 defines a foreground area 11 that is associated with the object in the original image 1, and a background area 12 that is associated with the remaining parts of the original image 1.

In step 72, the processor 202 identifies a plurality of contour points 111 that define a contour of the object, and obtains a centroid of the object (O) based on the contour points 111. In the example of FIG. 5, the processor 202 performs binarization on the original image 1 so as to distinguish the object (i.e., the foreground area 11) from the background area 12 in the original image 1, identifies the contour of the foreground area 11, and then identifies the contour points 111 on the contour. In this example, the object has an elliptical shape, the contour points 111 constitute a circumference of the object, and the centroid of the object (O) is the centre of the elliptical shape of the object. It should be noted that the contour points 111 shown in FIG. 5 are only for exemplary purposes, and a mass of the contour points 111 that compose the contour of the foreground area 11 may be identified.

In step 73, the processor 202 performs a curve fitting operation to construct a fitted curve 2 using the centroid of the object, the contour points 111 and a fitting function. The fitted curve 2 is composed of a plurality of curve points that correspond to the contour points respectively. In use, the operations of step 73 may be implemented by the processor 202 executing commercially available statistical software applications.

Taking the elliptical object shown in FIG. 5 as an example, the fitting function is an ellipse function expressing a standard ellipse, and the fitted curve 2 will be elliptical. The fitting function may be expressed by the following equation:

$$\frac{{( x - {x}^{′} )}^{2}}{{m}^{2}} + \frac{{( y - {y}^{′} )}^{2}}{{n}^{2}} = 1$$

where (x,y) is a set of variables that represent the contour points, (x′,y′) represents a coordinate of the centroid of the object (O), m represents a width of the fitted curve 2 (also known as a semi-major axis), and n represents a height of the fitted curve 2 (also known as a semi-minor axis).

It is noted that with the fitting function, the processor 202 is configured to perform the curve fitting operation with the centroid of the object (O) and at least four contour points 111 (labeled A, B, C and D on FIG. 5) as data points. As a result, the four contour points (A, B, C, D) are included in the curve points of the fitted curve 2. In practice, all of the contour points 111 serve as the curve points in this embodiment, respectively.

In step 74, the processor 202 obtains a plurality of characteristic lines 4. Each of the characteristic lines 4 is a straight line defined by the centroid of the object (O) and an end point that is obtained from the contour points, and has a predetermined width (e.g., a predetermined number of pixels). It is noted that in this embodiment, the end point of each of the characteristic lines 4 is one of the curve points, and

FIG. 5 shows four exemplary characteristic lines 4 defined by the centroid of the object (O) and the curve points (A, B, C and D), respectively. In one embodiment, each curve point is a pixel on the fitted curve 2 and the number of curve points equals the number of pixels on the fitted curve 2.

In step 75, the processor 202 obtains, for each of the characteristic lines 4, a plurality of pixel value sets that correspond respectively with those of the pixels on the original image 1 that constitute the characteristic line 4.

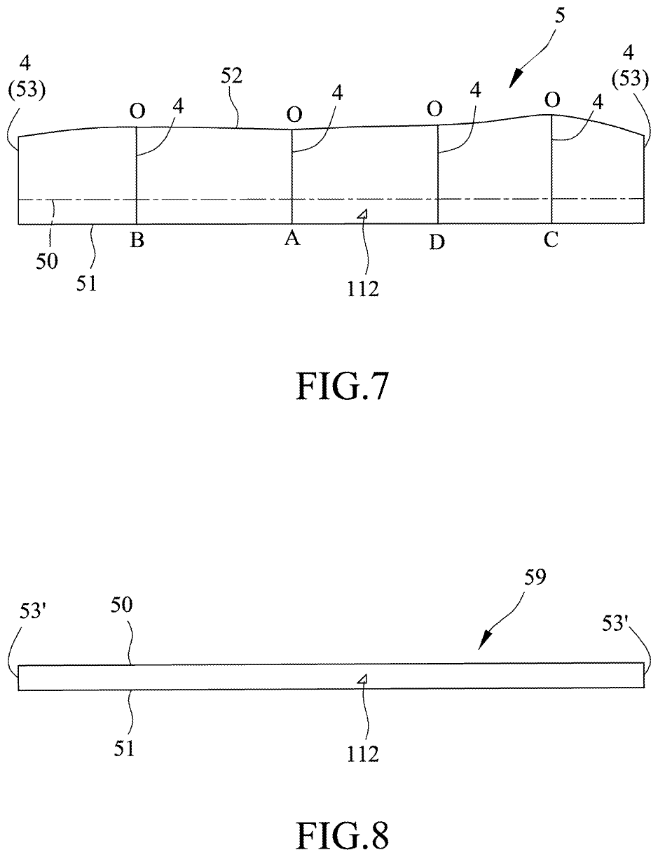

In step 76, the processor 202 constructs a reconstructed image 5 (see FIG. 7) based on the pixel value sets of the characteristic lines 4 obtained in step 75. Specifically, as shown in FIG. 7, the processor 202 rearranges the characteristic lines 4 by aligning the end points (i.e., the curve points) on one side to form a straight edge 51 and making the characteristic lines 4 adjoin each other side by side, so as to construct the reconstructed image 5 (only two characteristic lines 4 that are spaced apart from each other are depicted for illustration purposes).

Specifically, the reconstructed image 5 is constituted by the pixel value sets of each of the characteristic lines 4, and is defined by the straight edge 51, an opposite edge 52 that is formed by duplicates of the centroid of the object (O) which respectively define the characteristic lines 4, and two of the characteristic lines 4 that are arranged furthest to the sides and that serve as two perpendicular edges 53. It is noted that the opposite edge 52 is not a straight line as the lengths of the characteristic lines 4 vary.

Afterward, the processor 202 may control the display 212 to display the reconstructed image 5, enabling the user to inspect the reconstructed image 5 to locate the defect 112. Once the defect 112 is found, the user may operate the operation interface 210 to click on the defect 112 on the reconstructed image 5, and the processor 202, in response to the user operation of clicking, controls the display 212 to display and enlarge a part of the original image 1 on which the defect 112 is located.

In some embodiments, after step 76, the processor 202 is further configured to perform the following steps.

In step 77, the processor 202 defines a cutting line 50 that is parallel to the straight edge 51 in the reconstructed image 5. In this embodiment, the cutting line 50 is defined as a straight line that is parallel to and spaced apart from the straight edge 51 by a predetermined distance (d). For example, in the case that the defect 112 is a residue of EBR, a location of the defect 112 typically is close to an edge of the semiconductor wafer, and a distance from the location of the defect 112 to the edge of the semiconductor wafer may be smaller than 7 millimeters. As a result, the predetermined distance (d) may be set at 7 millimeters.

In step 78, the processor 202 removes of a portion of the reconstructed image 5 extending from the cutting line 50 to the opposite edge 52, so as to obtain a cut image 59 defined by the cutting line 50, the straight edge 51 and two segments 53′ respectively of the perpendicular edges 53.

It is noted that, since the predetermined distance (d) is significantly smaller than the smallest radius of the object (typically inches), a size of the cut image 59 is also significantly smaller than the reconstructed image 5. In this manner, the inspection of the defect 112 may be done with relatively more ease.

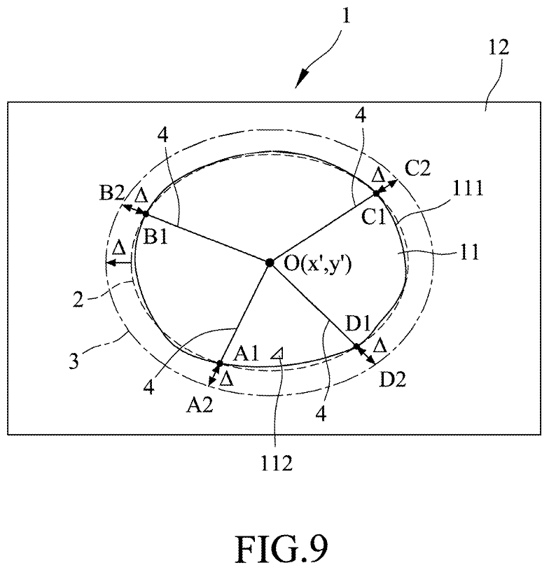

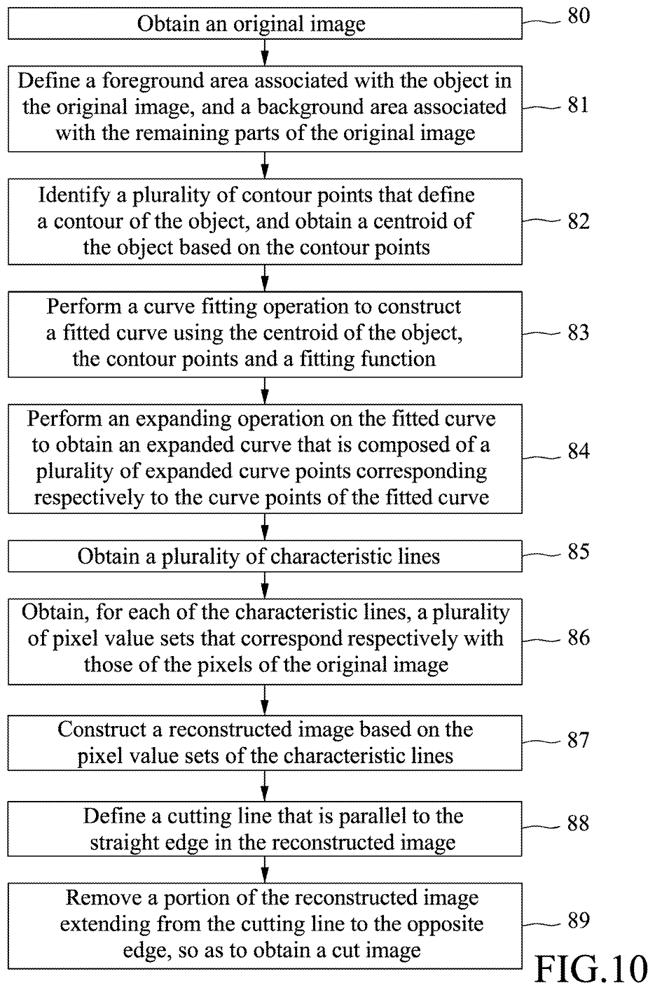

FIG. 10 is a flow chart illustrating steps of a method for reconstructing an original image (e.g., the original image 1 shown in FIG. 9) according to one embodiment of the disclosure. In this embodiment, the object may be a semiconductor wafer having an approximately elliptical shape, as shown in FIG. 9. The object also has a defect 112.

In step 80, the processor 202 obtains an original image (e.g., the original image 1 shown in FIG. 9). In some embodiments, the original image 1 may be captured by the image capturing unit 208, or received from an external source via the communication component 206 over a network such as the Internet. As shown in FIG. 9, the original image 1 contains an object that may be a semiconductor wafer in this embodiment, and that has a defect 112.

In step 81, the processor 202 defines a foreground area 11 that is associated with the object in the original image 1, and a background area 12 that is associated with the remaining parts of the original image 1.

In step 82, the processor 202 identifies a plurality of contour points 111 that define a contour of the object, and obtains a centroid of the object (O) based on the contour points 111. In the example of FIG. 9, the processor 202 performs binarization on the original image 1 so as to distinguish the object (i.e., the foreground area 11) from the background area 12 in the original image 1, identifies the contour of the foreground area 11, and then identifies the contour points 111 on the contour. In this example, the object has a shape that is close to an ellipse, the contour points 111 constitute a circumference of the object. Similar to the above, the contour points 111 shown in FIG. 9 are only for exemplary purposes, and a mass of the contour points 111 that compose the contour of the foreground area 11 may be identified.

In step 83, the processor 202 performs a curve fitting operation to construct a fitted curve 2 (indicated by a dashed line in FIG. 9) using the centroid of the object (O), the contour points 111 and a fitting function. The fitted curve 2 is composed of a plurality of curve points. In use, the operations of step 83 may be implemented by the processor 202 executing commercially available statistical software applications.

Taking the approximately elliptical object shown in FIG. 9 as an example, the fitting function is an ellipse function expressing a standard ellipse, and the fitted curve 2 will be elliptical. The fitting function may be expressed by the following equation:

$$\frac{{( x - {x}^{′} )}^{2}}{{m}^{2}} + \frac{{( y - {y}^{′} )}^{2}}{{n}^{2}} = 1$$

where (x,y) is a set of variables that represent the contour points, (x′,y′) represents a coordinate of the centroid of the object (O), m represents a width of the fitted curve 2 (also known as a semi-major axis), and n represents a height of the fitted curve 2 (also known as a semi-minor axis).

It is noted that with the fitting function, the processor 202 is configured to perform the curve fitting operation with the centroid of the object (O) and at least four contour points 111 (labeled A1, B1, C1 and D1 on FIG. 9) as data points. As a result, the four contour points (A1, B1, C1, D1) are included in the curve points of the fitted curve 2.

In step 84, the processor 202 performs an expanding operation on the fitted curve 2 to obtain an expanded curve 3 that is composed of a plurality of expanded curve points corresponding respectively to the curve points of the fitted curve 2. Specifically, each of the expanded curve points is a point radially spaced apart from the corresponding one of the curve points in a direction away from the centroid of the object (O) by a predetermined expanding distance (Δ). The predetermined expanding distance (Δ) may be, for example, one millimeter. In this manner, four expanded curve points (labeled A2, B2, C2 and D2 on FIG. 9) on the expanded curve 3 are obtained from the four curve points (A1, B1, C1 and D1) of the fitted curve 2. In practice, a mass of expanded curve points will be obtained and correspond respectively to all of the curve points of the fitted curve 2 in this embodiment.

It is noted that in this embodiment, the object is not in a typical elliptical shape, and there may be some irregularities on the edge (indicated by the solid line in FIG. 9). In such a case, the fitted curve 2 may not contain all parts of the object. Therefore, the expanding operation is additionally performed to ensure that the resulting expanded curve 3 contains the entirety of the object.

In step 85, the processor 202 obtains a plurality of characteristic lines 4. Each of the characteristic lines 4 is a straight line defined by the centroid of the object (O) and an end point that is obtained from the contour points, and has a predetermined width (e.g., a predetermined number of pixels). It is noted that in this embodiment, the end point of each of the characteristic lines 4 is a corresponding one of the expanded curve points, and FIG. 9 shows four exemplary characteristic lines 4 defined by the centroid of the object (O) and the expanded curve points (A2, B2, C2 and D2), respectively.

In step 86, the processor 202 obtains, for each of the characteristic lines 4, a plurality of pixel value sets that correspond respectively with those of the pixels on the original image 1 that constitute the characteristic line 4.

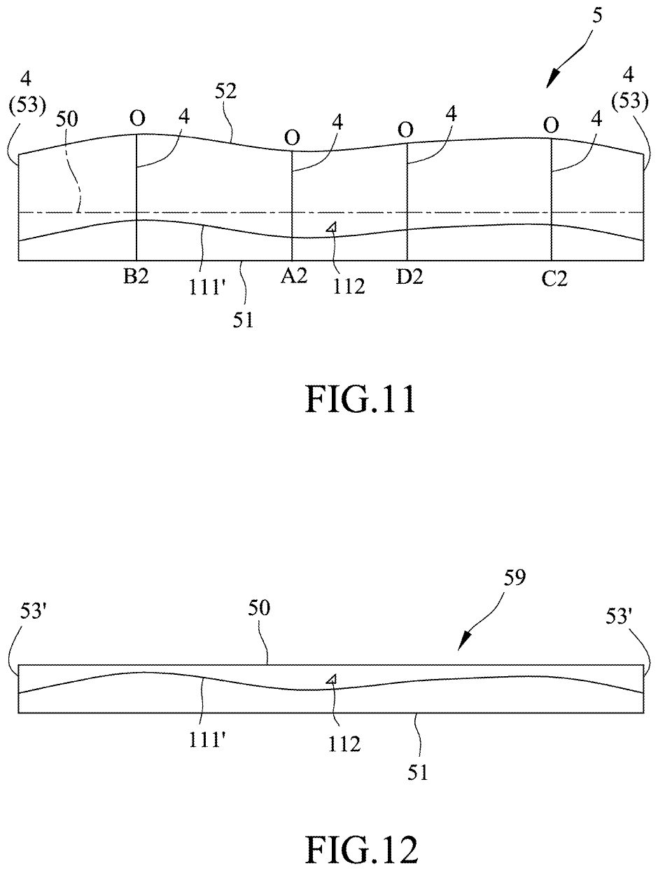

In step 87, the processor 202 constructs a reconstructed image 5 (see FIG. 11) based on the pixel value sets of the characteristic lines 4 obtained in step 86. Specifically, as shown in FIG. 11, the processor 202 rearranges the characteristic lines 4 by aligning the end points (i.e., the expanded curve points) on one side to forma straight edge 51 and making the characteristic lines 4 adjoin each other side by side (only two characteristic lines 4 that are spaced apart from each other are depicted for illustration purposes), so as to construct the reconstructed image 5. Specifically, the reconstructed image 5 is constituted by the pixel value sets of each of the characteristic lines 4, and is defined by the straight edge 51, an opposite edge 52 that is formed by duplicates of the centroid of the object (O) which respectively define the characteristic lines 4, and two characteristic lines 4 that are arranged furthest to the sides and that serve as two perpendicular edges 53. It is noted that the opposite edge 52 is not a straight line as the lengths of the characteristic lines 4 vary. Afterward, the processor 202 may control the display 212 to display the reconstructed image 5, enabling the user to inspect the reconstructed image 5 to locate the defect 112. Once the defect 112 is found, the user may operate the operation interface 210 to click on the defect 112 on the reconstructed image 5, and the processor 202, in response to the user operation of clicking, controls the display 212 to display and enlarge a part of the original image 1 on which the defect 112 is located.

In some embodiments, after step 87, the processor 202 is further configured to perform the following steps.

In step 88, the processor 202 defines a cutting line 50 that is parallel to the straight edge 51 in the reconstructed image 5. In this embodiment, the cutting line 50 is defined as a straight line that is parallel to and spaced apart from the straight edge 51 by a predetermined distance (d). For example, in the case that the defect 112 is a residue of EBR, a location of the defect 112 typically is close to an edge of the semiconductor wafer, and a distance from the location of the defect 112 to the edge of the semiconductor wafer may be smaller than 7 millimeters. As a result, the predetermined distance (d) may be set at 7 millimeters.

In step 89, the processor 202 removes of a portion of the reconstructed image 5 extending from the cutting line 50 to the opposite edge 52, so as to obtain a cut image 59 defined by the cutting line 50, the straight edge 51 and two segments 53′ respectively of the perpendicular edges 53.

It is noted that, since the predetermined distance (d) is significantly smaller than the smallest radius of the object (typically inches), a size of the cut image 59 is also significantly smaller than the reconstructed image 5. In this manner, the inspection of the defect 112 may be done with relatively more ease.

To sum up, embodiments of the disclosure provide a method for reconstructing an original image. In different embodiments, the method includes operations to identify an object in the original image, obtain contour points of a contour of the object, obtain the characteristic lines that include the pixels of the object in the original image, and rearrange the characteristic lines so as to obtain a reconstructed image. The above operations are capable of making the size of the reconstructed image less than that of the original image since only a portion of the original image that corresponds to the object is employed in constructing the reconstructed image. In some cases, the size of the reconstructed image may be further reduced by removing a part of the reconstructed image beyond the cutting line (in which a defect is unlikely to occur), so as to enable the user to inspect the defect with more ease.

Additionally, in the cases that the object has non-standard shapes (e.g., approximate ellipse), the method further includes operations to construct a fitted curve, and to proceed to construct the reconstructed image based on the fitted curve so as to ensure that all information related to the object is contained in the reconstructed image. In the case that the object has a shape that is not a strict ellipse, the method further includes operations to expand the fitted curve to obtain an expanded curve and to proceed to construct the reconstructed image based on the expanded curve so as to ensure that all information related to the object is contained in the reconstructed image.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method for reconstructing an image to be implemented using a processor of an electronic device, the method comprising steps of:
a) obtaining an original image;
b) defining a foreground area that is associated with an object in the original image;
c) identifying a plurality of contour points that define a contour of the object, and obtaining a centroid of the object based on the contour points;
d) obtaining a plurality of characteristic lines, each of the characteristic lines being defined by the centroid of the object and an endpoint that is obtained from the contour points;
e) obtaining, for each of the characteristic lines, a plurality of pixel value sets that correspond respectively with a plurality of pixels on the original image that constitute the characteristic line; and
f) rearranging the characteristic lines by aligning the end points on one side to form a straight edge and making the characteristic lines adjoin each other side by side, so as to construct a reconstructed image.

2. The method of claim 1, further comprising, after step f):
defining a cutting line that is parallel to the straight edge in the reconstructed image;
removing a portion of the reconstructed image extending from the cutting line to an opposite edge of the reconstructed image that is opposite to the straight edge, so as to obtain a cut image.

3. The method of claim 1, wherein in step d), for each of the characteristic lines, the end point is a corresponding one of the contour points.

4. The method of claim 1, further comprising, between steps c) and d):
performing a curve fitting operation to construct a fitted curve using the centroid of the object, the contour points and a fitting function, the fitted curve being composed of a plurality of curve points;
wherein for each of the characteristic lines, the end point is one of the curve points.

5. The method of claim 4, the object being a semiconductor wafer and elliptical, wherein the fitting function is an ellipse function expressing a standard ellipse and the fitted curve is elliptical.

6. The method of claim 1, further comprising, between steps c) and d):
performing a curve fitting operation to construct a fitted curve using the centroid of the object, the contour points and a fitting function, the fitted curve being composed of a plurality of curve points; and
performing an expanding operation on the fitted curve to obtain an expanded curve that is composed of a plurality of expanded curve points, wherein each of the expanded curve points is a point radially spaced apart from a corresponding one of the curve points in a direction away from the centroid of the object by a predetermined expanding distance;
wherein for each of the characteristic lines, the end point is one of the expanded curve points.

7. The method of claim 6, the object being a semiconductor wafer and having an approximately elliptical shape, wherein the fitting function is an ellipse function expressing a standard ellipse and the fitted curve is elliptical.

8. The method of claim 1, wherein step c) includes performing binarization on the original image.
